(19) United States
(12) Patent Application Publication
(10) Pub. No.: US 2025/0279819 A1
(43) Pub. Date: Sep. 4, 2025

(54) TRANSMISSION CONFIGURATION INDICATOR UPDATE FOR TIME DOMAIN BEAM PREDICTION

(71) Applicant: Apple Inc., Cupertino, CA (US)

(72) Inventors: Yushu Zhang, Beijing (CN); Weidong Yang, San Diego, CA (US); Wei Zeng, Saratoga, CA (US); Huaning Niu, San Jose, CA (US); Haitong Sun, Cupertino, CA (US); Oghenekome Oteri, San Diego, CA (US); Hong He, San Jose, CA (US); Dawei Zhang, Saratoga, CA (US)

(21) Appl. No.: 18/858,677

(22) PCT Filed: Apr. 28, 2022
(86) PCT No.: PCT/CN2022/089803

§ 371 Date: Oct. 21, 2024

(51) Int. Cl. H04B 7/06; H04W 72/1273

(52) U.S. Cl. CPC H04B 7/06952; H04W 72/1273

(57) ABSTRACT

A user equipment (UE) includes a transceiver and a processor. The processor is configured to receive, via the transceiver, at least one indication to activate at least one transmission configuration indicator (TCI) state, and at least one action delay configured to activate the at least one TCI state. The at least one TCI state identifies at least one beam that is predicted to be of satisfactory quality for at least one transmission between the UE and at least one cell at a future time. The processor is also configured to identify the at least one beam in accord with the TCI state, and to activate the at least one TCI state in accord with the at least one action delay.

### TECHNICAL FIELD

This application relates generally to wireless communication systems, including methods and implementations of updating at least one transmission configuration indicator (TCI) state.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIGS. 2A and 2B illustrate example TCI indications for a component carrier (CC) configured in a joint TCI configuration mode.

FIGS. 3A and 3B illustrate example TCI indications for a CC configured in a separate TCI configuration mode.

FIG. 4A shows example TCI state lists for each of first and second CCs, and a common TCI identifier (ID) for the first and second CCs.

FIG. 4B shows an example timeline for a common TCI ID switch.

FIG. 5 shows an example neural network architecture that may be employed by a base station or a UE to predict one or more beams that may be of satisfactory quality, for at least one transmission (on a DL or an UL) between a UE and at least one cell, at a future time.

FIG. 6 shows an example method of wireless communication by a UE, which method may be used to activate one or more TCI states.

FIG. 7A shows a format of a medium access control (MAC) control element (CE) (MAC CE) that may identify a number of TCI states or TCI codepoints corresponding to at least one TCI state that is to be activated.

FIG. 7B shows a format of a MAC CE that may identify multiple TCI states or TCI codepoints corresponding to at least one TCI state that is to be activated.

FIGS. 8A and 8B provide examples of a no overwrite scenario (FIG. 8A) and an overwrite scenario (FIG. 8B).

FIG. 9 shows an example method of wireless communication by a base station, which method may be used to activate one or more TCI states.

FIG. 10 shows an example method of wireless communication by a UE, which method may be used to apply one or more TCI states.

FIG. 11 shows an example timeline for UE beam refinement.

FIG. 12 shows an example timeline for reference signal received power (RSRP) reporting for further beam predication.

FIG. 13 shows an example method of wireless communication by a base station, which method may be used to indicate one or more TCI states.

FIG. 14 shows an example method of wireless communication by a UE, which method may be used to predict and recommend one or more TCI states.

FIG. 15 shows an example method of wireless communication by a base station, which method may be used to receive one or more TCI states recommended by a UE.

FIGS. 16A and 16B show example flow diagrams for transmission of one or more recommended TCI states from a UE to a base station.

FIG. 17 illustrates an example architecture of a wireless communication system, according to embodiments disclosed herein.

FIG. 18 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

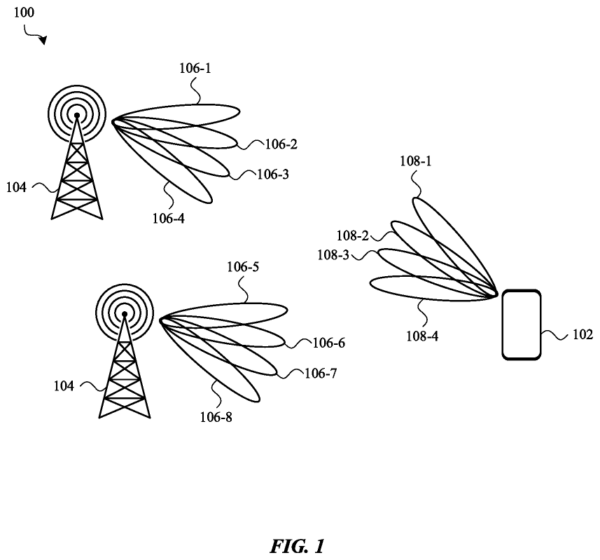

FIG. 1 shows an example wireless communication system 100, according to embodiments described herein. The wireless communication system 100 may operate in accord with the LTE system standards, 5G or NR system standards, or other standards provided by 3GPP technical specifications.

As shown in FIG. 1, the wireless communication system 100 may include a UE 102 and one or more base stations 104 (e.g., eNBs or gNBs). The UE 102 may communicate with one or both of the base stations 104, sequentially (e.g., in a handover scenario) or simultaneously (e.g., in a carrier aggregation (CA) scenario). The UE 102 may also communicate with one or multiple transmission and reception points (multi-TRPs), on one or more base stations 104, in a multi-TRP mode. The UE 102 may also communicate with other base stations 104. In some embodiments, the UE 102 may be one of multiple UEs that simultaneously or contemporaneously communicate with one or both of the base stations 104 (or other base stations). In some embodiments, one or both of the base stations 104, alone or in combination with one or more other base stations, may form part or all of a cellular RAN.

In some cases, one or both of the base stations 104 may transmit one or more DL channels to the UE 102. The DL channels may be transmitted on one or multiple DL beams 106 (e.g., DL beams 106-1, 106-2, 106-3, and/or 106-4, or DL beams 106-5, 106-6, 106-7, and/or 106-8). Similarly, the UE 102 may transmit one or more UL channels to the base station 104. The UL channels may be transmitted on one or multiple UL beams 108 (e.g., UL beam 108-1, 108-2, 108-3, and/or 108-4).

In some cases, the UE 102 and a base station 104 may communicate on a single CC. In other cases, the UE 102 and the base station 104 may communicate on multiple CCs in a carrier aggregation (CA) mode. The UE 102 may also communicate with more than one base station 104 simultaneously over a set of multiple CCs.

In 3GPP Release 17 (Rel-17), a TCI framework for unified beam management (BM) is described. In accord with the TCI framework, radio resource control (RRC) may be used to identify a set of TCI states (e.g., a TCI state list or pool) for at least one of a number of CCs that have been configured to a UE in a CA mode. A TCI state pool may be identified for one or more CCs and, in some cases, shared with one or more other CCs. A base station may indicate to the UE, in a MAC CE or downlink control information (DCI, such as DCI format 1_1/1_2), which TCI state in a TCI state list or pool is to be used for transmission of various DL and/or UL channels over a CC. The TCI state may be indicated to the UE by means of a TCI ID.

The TCI states in a TCI state list may include TCI states associated with one or more different TCI configuration modes. For example, a TCI state may be provided for a joint TCI configuration mode (i.e., a mode in which a joint TCI state indicates a downlink reference signal for beam indication for both DL and UL channels) or a separate TCI configuration mode (i.e., a mode in which a separate TCI state (e.g., a DL TCI state or an UL TCI state) indicates a downlink reference signal for beam indication for DL channels or UL channels, but not both).

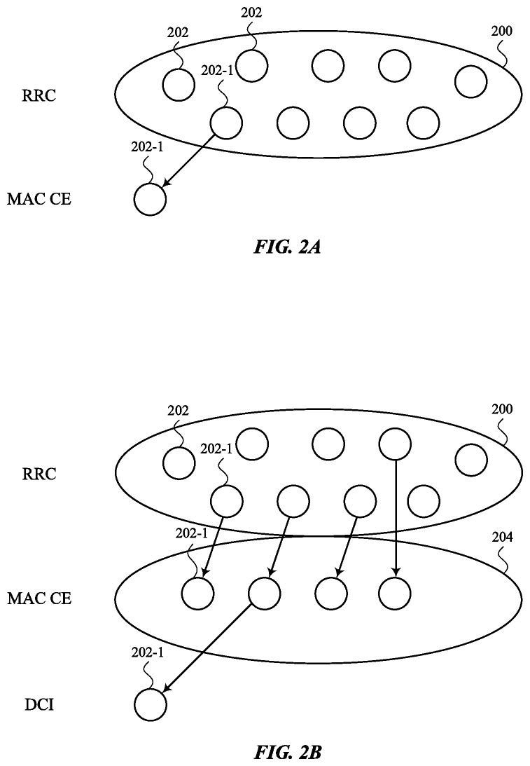

FIGS. 2A and 2B illustrate example TCI indications for a CC configured in a joint TCI configuration mode. As shown in each of FIGS. 2A and 2B, a base station may use RRC signaling to identify, for a UE, a TCI state list (or pool) 200 including a number of possible joint TCI states 202 for a CC. As shown in FIG. 2A, the base station may indicate, to the UE and in a MAC CE, which of the joint TCI states 202 (e.g., joint TCI state 202-1) is to be used by a CC for receiving DL channels and/or transmitting UL channels over the CC. Alternatively, and as shown in FIG. 2B, the base station may indicate, to the UE and in DCI, which of the joint TCI states 202 (e.g., joint TCI state 202-1) is to be used by a CC for receiving DL channels and/or transmitting UL channels over the CC. Optionally, the base station may indicate a down-selection of “active” joint TCI states 204 in a MAC CE, and then indicate a selection of a joint TCI state from among the down-selection of active joint TCI states 204. In either of the embodiments shown in FIGS. 2A and 2B, the joint TCI state 202-1 may be indicated to the UE by means of a TCI ID.

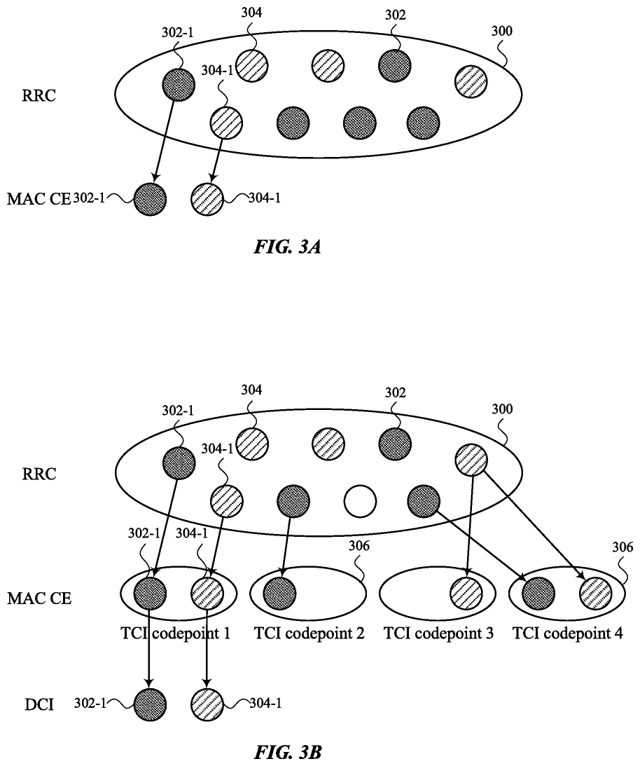

FIGS. 3A and 3B illustrate example TCI indications for a CC configured in a separate TCI configuration mode. As shown in each of FIGS. 3A and 3B, a base station may use RRC signaling to identify, for a UE, a TCI state list (or pool) 300 including a number of possible separate TCI states (e.g., DL TCI states 302 and UL TCI states 304) for a CC. As shown in FIG. 3A, the base station may indicate, to the UE and in a MAC CE, which of the separate TCI states 302 (e.g., DL TCI state 302-1 and UL TCI state 304-1) are to be used by a CC for receiving DL channels and/or transmitting UL channels over the CC. Alternatively, and as shown in FIG. 3B, the base station may indicate, to the UE and in DCI, which of the separate TCI states 302 (e.g., DL TCI state 302-1 and UL TCI state 304-1) are to be used by a CC for receiving DL channels and/or transmitting UL channels over the CC. Optionally, the base station may indicate a down-selection of “active” separate TCI states 306 (TCI codepoints) in a MAC CE, and then indicate a selection of one or more separate TCI states in terms of a selected TCI codepoint. Although FIGS. 3A and 3B both show selections of a DL TCI state 302-1 and an UL TCI state 304-1, a base station may alternatively select only a DL TCI state or an UL TCI state, as illustrated by TCI codepoints 2 and 3. In either of the embodiments shown in FIGS. 3A and 3B, the separate TCI states 302-1 and 304-1 may be indicated to the UE by means of a TCI ID, which in these examples may include a TCI codepoint.

An indicated TCI ID can be applied to (i.e., may be common to) multiple channels within a serving cell, or across multiple serving cells (or CCs) in a CA scenario. A target set of serving cells, to which a TCI ID is to be applied, may be identified in a serving cell list configured by RRC signaling.

TCI state list sharing across serving cells is supported. A base station may optionally configure a TCI state list by RRC for one BWP in a serving cell. When a TCI state list is not configured, the TCI state list for a reference BWP in a serving cell may be used.

To simplify beam management, a base station may provide, to a UE and in a MAC CE or DCI, a common TCI ID indication. A common TCI ID may identify a set of commonly indexed TCI states, in the TCI state lists of multiple CCs, that is to be applied to the set of multiple CCs. The common TCI ID may be associated with the same or different TCI states in the TCI state lists for different CCs.

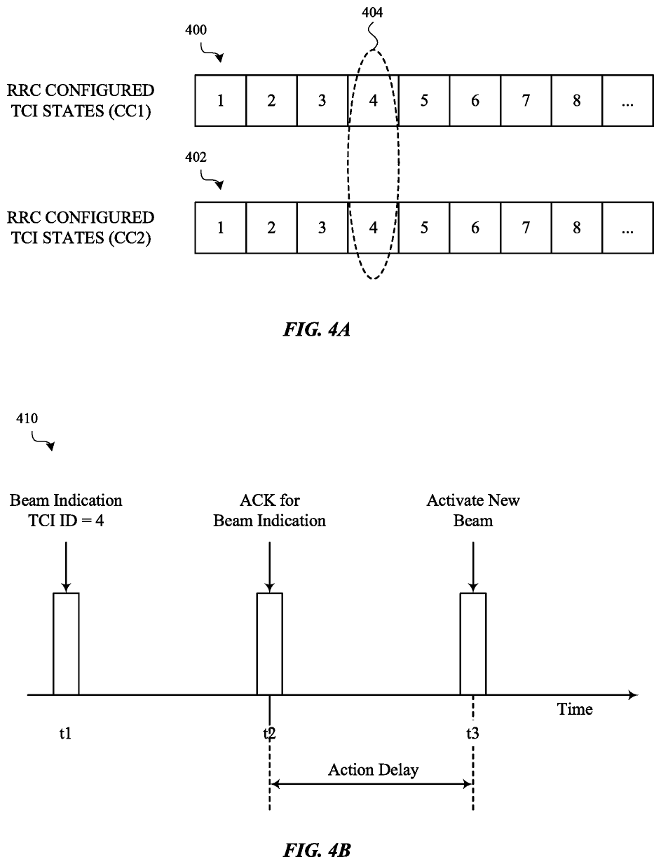

FIG. 4A shows example TCI state lists 400, 402 for each of first and second CCs, and a common TCI ID 404 for the first and second CCs. The first and second CCs are respectively identified as CC1 and CC2. The RRC configured TCI state list 400, 402 for each CC includes TCI states that are consecutively number 1, 2, 3, 4, and so on for each CC. By way of example, common TCI ID 4 is associated with TCI state 4 for each of CC1 and CC2. TCI state 4 may be the same for both CC1 and CC2, or TCI state 4 may be different for each of CC1 and CC2.

From time-to-time, a base station may switch the common TCI ID that is to be applied to a set of configured CCs for a UE. FIG. 4B shows an example timeline 410 for such a switch. At time t1, the UE may be communicating with the base station, in a CA mode, in accord with a first common TCI ID (e.g., common TCI ID 2). Also at time t1, the UE may receive, from the base station, a command to switch to a second common TCI ID (e.g., common TCI ID 4). In response to receiving the command, the UE may transmit, to the base station, an acknowledgement (ACK) of the command. The ACK may be transmitted at time t2, subsequent to time t1. Following transmission of the ACK, the UE may decode the second common TCI ID, optionally perform a receive (Rx) beam sweep, and perform other operations before the second common TCI ID is activated at time t3, subsequent to time t2. The time period between t2 and t3 is referred to as an action delay (i.e., a delay that is incurred before the UE can activate (or apply) the second common TCI ID to its uplink (UL) and/or downlink (DL) communications with the base station). For a MAC CE based TCI indication, the action delay is predefined as 3 milliseconds (ms) after the transmission of the ACK for the MAC CE. For a DCI based TCI indication, the action delay is X symbols after transmission of the ACK for the DCI or the ACK for a physical downlink shared channel (PDSCH) scheduled by the DCI (depending on whether the DCI schedules PDSCH or not). X is configured by RRC signaling and is based on UE capability.

In the above context, it may be useful to not only activate or indicate a TCI state, but to predict a TCI state that should be activated or indicated at a future time.

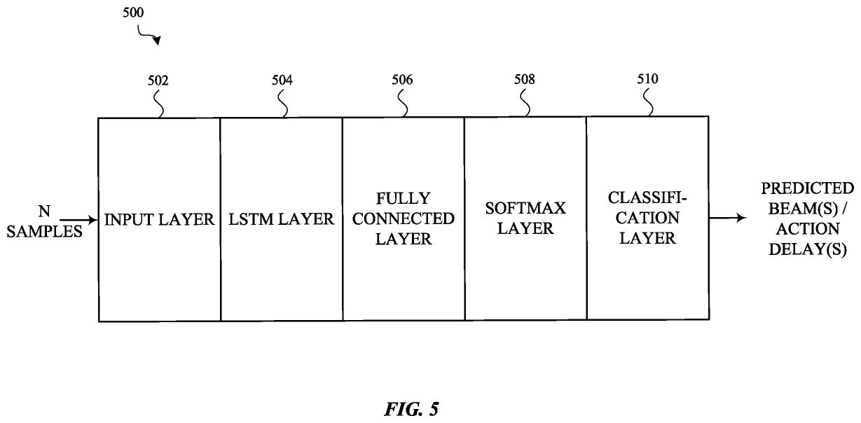

FIG. 5 shows an example neural network architecture 500 that may be employed by a base station or a UE to predict one or more beams that may be of satisfactory quality, for at least one transmission (on a DL or an UL) between a UE and at least one cell, at a future time. The neural network may also configure an action delay for application of all, or individual ones or subsets, of the beams. The neural network architecture is one example of the AI that may be used to predict one or more beams that may be of satisfactory quality, for at least one transmission between a UE and at least one cell, at a future time. Other forms of AI that may be used to predict the one or more beams include, for example, machine learning algorithms.

By way of example, the neural network architecture 500 may include at least one of an input layer 502, a long short-term memory (LSTM) layer 504, a fully connected layer 506, a softmax layer 508, and/or a classification layer 510. The input layer 502 may receive N samples of normalized best base station beam indices, as well as their corresponding RSRP measurements, in the past. The classification layer 510 may provide a beam prediction, such as one or more beams that may be of satisfactory quality, for at least one transmission between a UE and at least one cell, at a future time. The classification layer 510 may also provide one or more action delays configured to activate or indicate at least one TCI state that relies on at least one of the predicted beams.

The neural network architecture 500 may be operated in a training mode, initially, and then a time domain beam prediction mode. As the neural network architecture 500 is used for time domain beam prediction, it may receive feedback about its predictions (e.g., in the form of additional RSRP measurements) and continue to update its learning.

In some embodiments, the neural network architecture 500 may be operated in a training mode at a 3GPP network (e.g., at a base station), and in a time domain beam prediction mode at the 3GPP network (e.g., at the base station). In some embodiments, the neural network architecture 500 may be operated in a training mode at a 3GPP network (e.g., at a base station), and in a time domain beam prediction mode at a UE. In some embodiments, the neural network architecture 500 may be operated in a training mode at a UE, and in a time domain beam prediction mode at the UE. In some embodiments, the neural network architecture 500 may be operated in a training mode at a UE, and in a time domain beam prediction mode at a 3GPP network (e.g., at a base station).

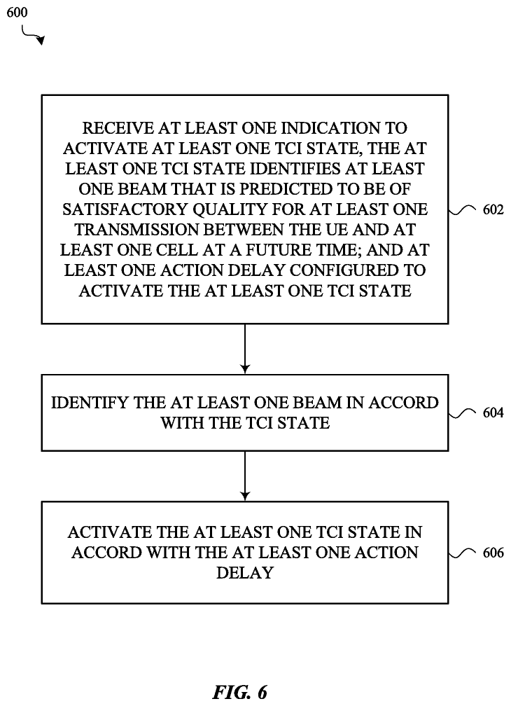

FIG. 6 shows an example method 600 of wireless communication by a UE, which method 600 may be used to activate one or more TCI states. The method 600 may be performed by a processor of the UE, and transmissions and receptions initiated by the processor may be made using a transceiver of the UE.

At 602, the method 600 may include receiving at least one indication to activate at least one TCI state, and at least one action delay configured to activate the at least one TCI state. The at least one TCI state may identify at least one beam that is predicted to be of satisfactory quality, for at least one transmission (on a DL or an UL) between the UE and at least one cell, at a future time. The at least one beam is “predicted” to be of satisfactory quality in that it is selected based on past, not current, beam measurements. This can save resources and/or enable TCI states to be activated and/or indicated more quickly. Each action delay may apply to one TCI state, or to more than one TCI state, in the at least one TCI state. Thus, the number of TCI states and number of action delays may or may not have a one-to-one correspondence.

At 604, the method 600 may include identifying the at least one beam in accord with the TCI state.

At 606, the method 600 may include activating the at least one TCI state in accord with the at least one action delay.

In some embodiments, AI may be trained by a 3GPP network (e.g., at a base station) and used to predict the at least one beam that will be of satisfactory quality, for at least one transmission between the UE and at least one cell, at a future time. In some embodiments, AI may be trained at the UE and reported to a base station (e.g., in RRC signaling). In either case, the AI may be used by the 3GPP network (e.g., at a base station) or the UE to predict the at least one beam, and to identify at least one TCI state based on the prediction. When the prediction is made by the UE, the prediction may be reported to a base station prior to commencement of the method 600.

An action delay “configured to” activate a TCI state (also referred to as a configured action delay) differs from the action delay that is currently described in 3GPP technical specifications in that it is “configured” and not “predefined.” However, in some cases, an action delay may be configured by selecting it from a set of configured or predefined candidate action delays, thus providing a bit more structure to how the action delay is configured. In contrast to the 3 ms action delay that is predefined in 3GPP technical specifications, an action delay that is “configured” to active a TCI state may have any value, and in some cases may be 40 ms or 80 ms (as examples).

In some embodiments of the method 600, the at least one indication to activate the at least one TCI state may be received in one or more MAC CEs. The MAC CE(s) may be applied at a particular time. The action delay(s) for the at least one TCI state may be indicated in the MAC CE(s) or in DCI. In some cases, a set of candidate action delays (i.e., possible action delay values) may be predefined for the UE, or configured for the UE by RRC signaling, and the action delay(s) for the at least one TCI state may be selected from a predefined first set of at least one candidate action delay and/or from a predefined second set of at least one candidate action delay. The selection may be made by indicating a value of the action delay, or providing an index that can be used to retrieve the value. If only one candidate action delay is configured, then the one candidate action delay may be used.

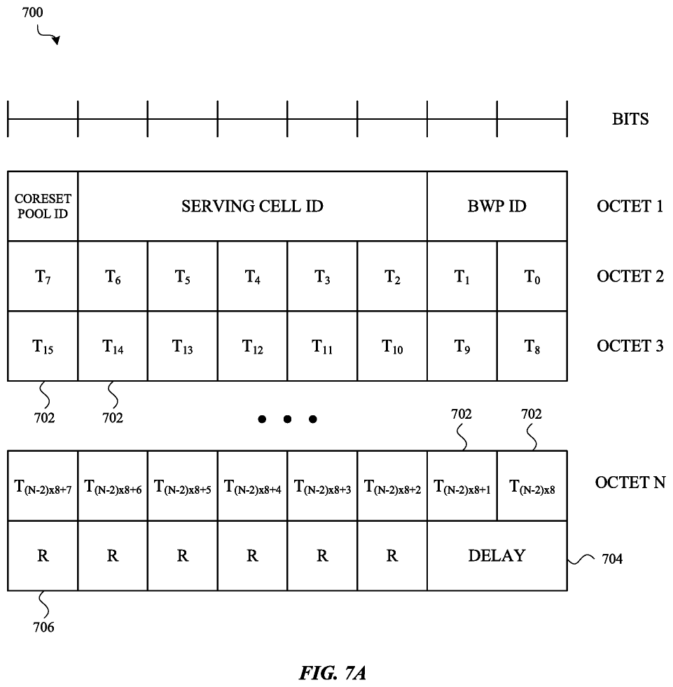

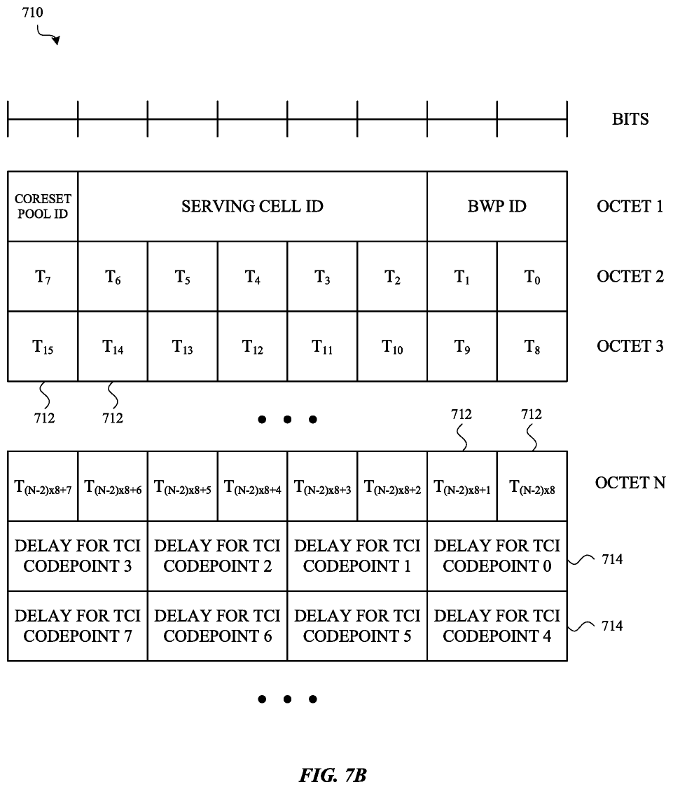

When the at least one indication to activate the at least one TCI state is received in one or more MAC CEs, and the action delay(s) for the at least one TCI state are indicated in the MAC CE(s), one or more action delays may be configured per MAC CE. For example, and as shown in FIG. 7A, a MAC CE 700 of the at least one MAC CE may identify a number of (one or more) TCI states or TCI codepoints 702 corresponding to the at least one TCI state that is to be activated, and the MAC CE 700 may identify an action delay 704 that applies to each of the number of TCI states or TCI codepoints 702. “R” indicates a reserved field 706, and other fields are defined in 3GPP TS 38.321 § 6.1.3.14. As an alternative example, and as shown in FIG. 7B, a MAC CE 710 of the at least one MAC CE may identify multiple (two or more) TCI states or TCI codepoints 712 corresponding to the at least one TCI state that is to be activated, and the MAC CE 710 may identify an action delay 714 per TCI state or TCI codepoint in the multiple TCI states or TCI codepoints 712.

When the at least one indication to activate the at least one TCI state is received in one or more MAC CEs, and the action delay(s) for the at least one TCI state are indicated in DCI, an action delay may be configured per MAC CE. For example, a MAC CE of the at least one MAC CE may identify a number of (one or more) TCI states or TCI codepoints corresponding to the at least one TCI state, and the method 600 may include receiving DCI to schedule a PDSCH containing the MAC CE. The DCI may identify an action delay that applies to each TCI state or

TCI codepoint of the number of TCI states or TCI codepoints identified in the MAC CE. In some cases, the action delay may be identified in a dedicated field that is introduced to indicate the action delay. In some cases, a set of candidate action delays may be configured in pdsch-timeDomainAllocationList, in RRC signaling, and a time domain resource allocation field in DCI can be used to select an action delay for the MAC CE. When multiple MAC CEs are transmitted for the purpose of indicating a set of TCI states that is to be activated, DCI may be used to indicate an action delay for each MAC CE, separately, or DCI may be used to indicate an action delay for all of the MAC CEs, jointly. Alternatively, only one MAC CE may be transmitted for TCI activation at a time. In some cases, an additional large candidate value for delay for hybrid automatic repeat request (HARQ)-ACK (HARQ-ACK) feedback can be introduced (e.g., a value of 40 ms delay can be added to a typical 3 ms HARQ-ACK delay).

In some embodiments of the method 600, the at least one indication to activate the at least one TCI state may be received in a single MAC CE. The MAC CE may be applied at a particular time. The MAC CE may identify at least one TCI codepoint corresponding to the at least one TCI state. Each TCI codepoint of the at least one TCI codepoint may be associated with one or multiple TCI states. In the case of multiple TCI states, different action delays may be indicated for different TCI states of the multiple TCI states.

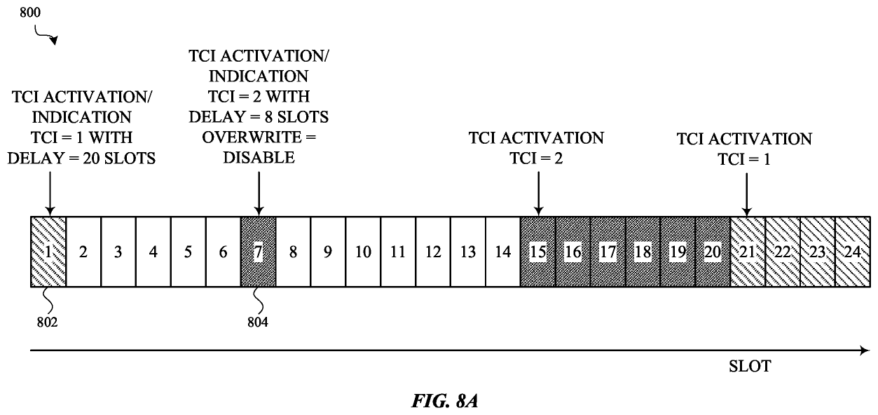

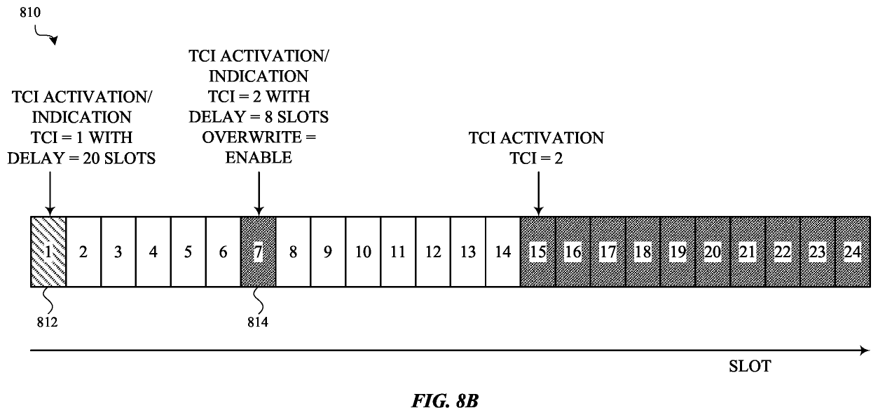

Regardless of whether the at least one indication to activate the at least one TCI state is received in one or more MAC CEs, and regardless of whether the at least one action delay is indicated in the MAC CE(s), DCI, RRC signaling, or some combination of the these, the method 600 may optionally include receiving an indication that indicates whether the at least one indication to activate the at least one TCI state overwrites (or clears) previous indications to activate at least one TCI state. Alternatively, the UE may be configured (e.g., via RRC signaling or predefined code) to automatically overwrite previous indications to activate at least one TCI state upon receiving a new indication to activate at least one TCI state. FIGS. 8A and 8B provide examples of a no overwrite scenario 800 (FIG. 8A) and an overwrite scenario 810 (FIG. 8B).

As shown in FIG. 8A, a MAC CE 802 including an indication to activate TCI ID 1 (TCI=1) with an action delay of 20 slots may be received in slot 1. A MAC CE 804 including an indication to activate TCI ID 2 (TCI=2) with an action delay of 8 slots may be received in slot 7. The later received MAC CE 804 may include an indication that overwrite is disabled. In slot 15, which is 8 slots after slot 7, TCI=2 may be activated, as indicated by the MAC CE 804. TCI=2 may remain activated until slot 21, which is 20 slots after slot 1. In slot 21, TCI=1 may be activated, as indicated by the MAC CE 802. Thus, the later indication to activate a TCI state did not overwrite the previous indication to activate a TCI state. Also, because the earlier indication to activate a TCI state is applied later in time, the earlier indication has the effect of overwriting the later indication. An indication to activate at least one TCI state, with overwrite disabled, may be applied before the action delay(s) for a previous indication, to ensure that the later indication does not overwrite the previous indication despite having overwrite disabled.

As shown in FIG. 8B, a MAC CE 812 including an indication to activate TCI ID 1 (TCI=1) with an action delay of 20 slots may be received in slot 1. A MAC CE 814 including an indication to activate TCI ID 2 (TCI=2) with an action delay of 8 slots may be received in slot 7. The later received MAC CE 814 may include an indication that overwrite is enabled. In slot 15, which is 8 slots after slot 7, TCI=2 may be activated, as indicated by the MAC CE 814. Because the later received MAC CE 814 included an indication that overwrite is enabled, the indication to activate TCI=1 may never be applied, and TCI=2 may remain activated until another indication to activate at least one TCI state is received. An indication to activate at least one TCI state, with overwrite enabled, may be applied before the action delay for a later indication to activate at least one TCI state, to ensure that the previous indication does not overwrite more than is intended.

In some cases, such as in the event of a blockage coming between the UE and a base station, a beam that is predicted to be of satisfactory quality at a future time, may no longer be predicted to be of satisfactory quality at a future time. This is one reason why the previously described overwrite capability may be needed. In some cases, the method 600 may include transmitting UE capability information indicating a minimum and/or maximum action delay supported by the UE.

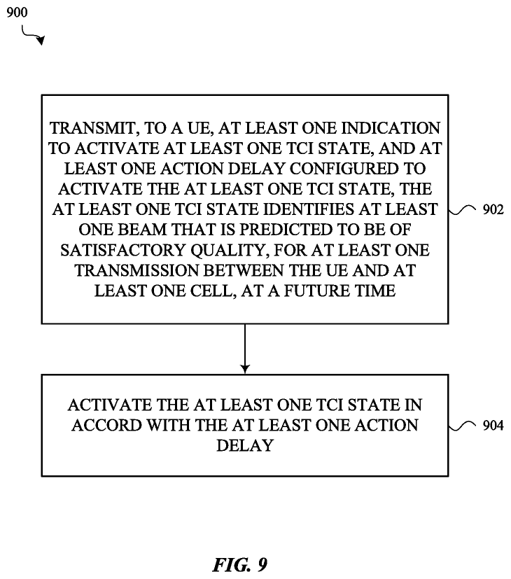

FIG. 9 shows an example method 900 of wireless communication by a base station (e.g., a gNB or eNB), which method 900 may be used to activate one or more TCI states. The method 900 may be performed by a processor of the base station, and transmissions and receptions initiated by the processor may be made using a transceiver of the base station.

At 902, the method 900 may include transmitting, to a UE, at least one indication to activate at least one TCI state, and at least one action delay configured to activate the at least one TCI state. The at least one TCI state may identify at least one beam that is predicted to be of satisfactory quality, for at least one transmission (on a DL or an UL) between the UE and at least one cell, at a future time. Each action delay may apply to one TCI state, or to more than one TCI state, in the at least one TCI state. Thus, the number of TCI states and number of action delays may or may not have a one-to-one correspondence.

At 904, the method 900 may include activating the at least one TCI state in accord with the at least one action delay.

The method 900 may be variously configured or modified as described with reference to FIG. 6.

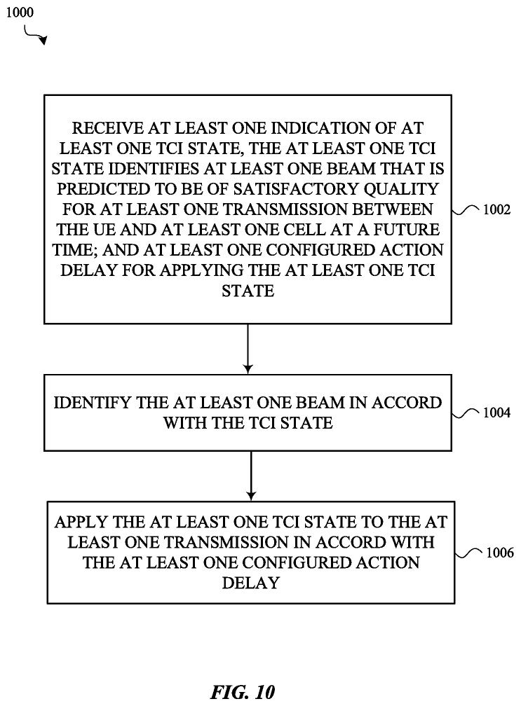

FIG. 10 shows an example method 1000 of wireless communication by a UE, which method 1000 may be used to apply one or more TCI states. The method 1000 may be performed by a processor of the UE, and transmissions and receptions initiated by the processor may be made using a transceiver of the UE.

At 1002, the method 1000 may include receiving at least one indication of at least one TCI state, and at least one action delay configured to apply the at least one TCI state to at least one transmission (on a DL or an UL) between the UE and at least one cell at a future time. The at least one TCI state may identify at least one beam that is predicted to be of satisfactory quality, for the at least one transmission between the UE and the at least one cell, at a future time. The at least one beam is “predicted” to be of satisfactory quality in that it is selected based on past, not current, beam measurements. This can save resources and/or enable TCI states to be activated and/or indicated more quickly. Each action delay may apply to one TCI state, or to more than one TCI state, in the at least one TCI state. Thus, the number of TCI states and number of action delays may or may not have a one-to-one correspondence.

At 1004, the method 1000 may include identifying the at least one beam in accord with the TCI state.

At 1006, the method 1000 may include applying the at least one TCI state to the at least one transmission in accord with the at least one action delay.

In some embodiments, AI may be trained by a 3GPP network (e.g., at a base station) and used to predict the at least one beam that will be of satisfactory quality, for at least one transmission between the UE and at least one cell, at a future time. In some embodiments, AI may be trained at the UE and reported to a base station (e.g., in RRC signaling). In either case, the AI may be used by the 3GPP network (e.g., at a base station) or the UE to predict the at least one beam, and to identify at least one TCI state based on the prediction. When the prediction is made by the UE, the prediction may be reported to a base station prior to commencement of the method 1000.

In some embodiments of the method 1000, the at least one indication of the at least one TCI state may be received in one or more MAC CEs, and the action delay(s) may be indicated in the MAC CE(s), DCI, RRC signaling, or some combination of these, as described with reference to FIG. 6.

In some embodiments of the method 1000, the at least one indication of the at least one TCI state may be received in DCI. In some cases, the DCI may include one or more dedicated fields that identify the at least one action delay. In some cases, a set of candidate action delays may be configured in pdsch-timeDomainAllocationList, in RRC signaling, and one or more time domain resource allocation fields in the DCI can be used to select the action delay(s) for one or more TCI states of the at least one TCI state. In some cases, a base station may indicate a single TCI state or TCI codepoint, and a single action delay for the TCI state or TCI codepoint, in one DCI. In other cases, a base station may indicate multiple TCI states or TCI codepoints, and one or more action delays for the multiple TCI states or TCI codepoints, in one DCI.

Regardless of whether the at least one indication to activate the at least one TCI state is received in one or more MAC CEs or DCI, and regardless of whether the at least one action delay is indicated in the MAC CE(s), DCI, RRC signaling, or some combination of the these, the method 1000 may optionally include receiving an indication (in a MAC CE or DCI) that indicates whether the at least one indication to activate the at least one TCI state overwrites (or clears) previous indications to activate at least one TCI state. Alternatively, the UE may be configured (e.g., via RRC signaling or predefined code) to automatically overwrite previous indications to activate at least one TCI state upon receiving a new indication to activate at least one TCI state.

In some embodiments, the method 1000 may include, before the at least one TCI state is applied to the at least one transmission, measuring a set of channel state information reference signal (CSI-RS) resources transmitted from at least one antenna port associated with the at least one TCI state, and refining at least one UE beam associated with the at least one TCI state. With regard to UE beam refinement, a base station may trigger a set of CSI-RS resources with repetition set to on (i.e., the CSI-RS resources in the set of CSI-RS resources will be from the same antenna port(s)). The CSI-RS resources should be quasi-co-located (QCLed) with the TCI state(s) to be activated or applied at a particular time. The CSI-RS resources may be transmitted to a predetermined or configured number of slots prior to the application time for the activated or indicated TCI state(s). The set of CSI-RS resources to be triggered by a base station may be indicated to the UE by MAC CE or DCI. In addition, a base station may trigger a set of CSI-RS resources for tracking for time/frequency offset tracking. The CSI-RS resources and UE beam refinement may be triggered by a single DCI or multiple DCIs.

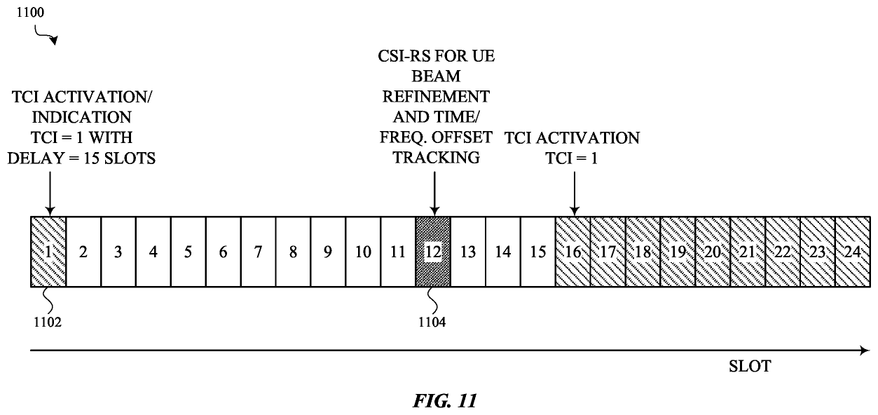

FIG. 11 shows an example timeline 1100 for UE beam refinement. At 1100, a UE may receive a MAC CE 1102 including a TCI activation or indication. The MAC CE 1102 may activate or indicate TCI ID 1 (TCI=1) with an action delay of 15 slots. In slot 12, 4 slots before the end of the action delay of 15 slots, the UE may measure a set of CSI-RS resources 1104 transmitted from an antenna port(s) used to transmit a DL beam associated with TCI=1, and may perform UE beam refinement and time/frequency offset tracking prior to TCI=1 being activated or applied in slot 16.

In some embodiments, the method 1000 may include, before the at least one TCI state is applied to the at least one transmission, determining a RSRP for at least one CSI-RS resource transmitted from at least one antenna port associated with the at least one TCI state. The method 1000 may also include transmitting, after a TCI state in the at least one TCI state is applied to the at least one transmission, at least one report based on the RSRP. The report may be a layer 1 (L1)-RSRP report, and may aid a 3GPP network in making additional beam predictions for additional future times, or making a revised beam prediction for a future time. The RSRP report may be made using a configured and/or indicated physical uplink control channel (PUCCH) or physical uplink shared channel (PUSCH) resource. The RSRP may be measured based on a CSI-RS resource indicated with the at least one TCI State, or based on the synchronization signal block (SSB) QCLed with the CSI-RS resource in the TCI State, or based on a CSI-RS resource triggered for UE beam refinement. The PUCCH or PUSCH resource may be configured by RRC signaling or a MAC CE, or indicated by DCI for TCI state activation and/or indication. The CSI-RS resource, beam indication, and RSRP report may be triggered by a single DCI or multiple DCIs.

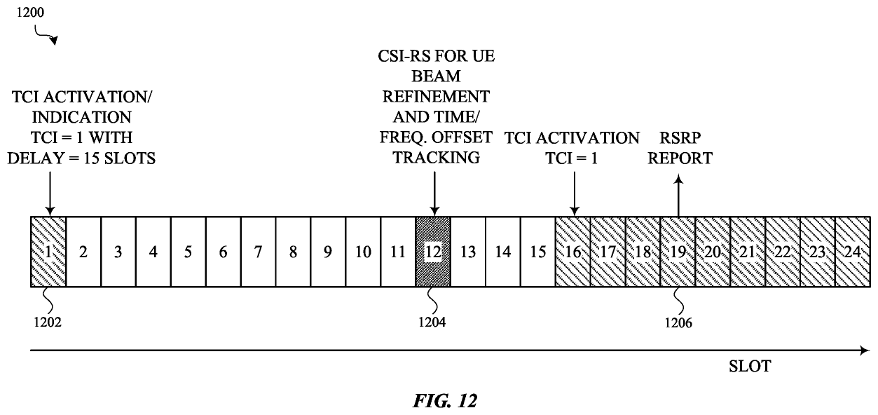

FIG. 12 shows an example timeline 1200 for RSRP reporting for further beam predication. At 1200, a UE may receive a MAC CE 1202 including a TCI activation or indication. The MAC CE 1202 may activate or indicate TCI ID 1 (TCI=1) with an action delay of 15 slots. In slot 12, 4 slots before the end of the action delay of 15 slots, the UE may determine a RSRP for at least one CSI-RS resource 1204 transmitted from at least one antenna port associated with the at least one TCI state. The UE may then transmit at least one report 1206 based on the RSRP in slot 19, after a TCI state in the at least one TCI state has been applied.

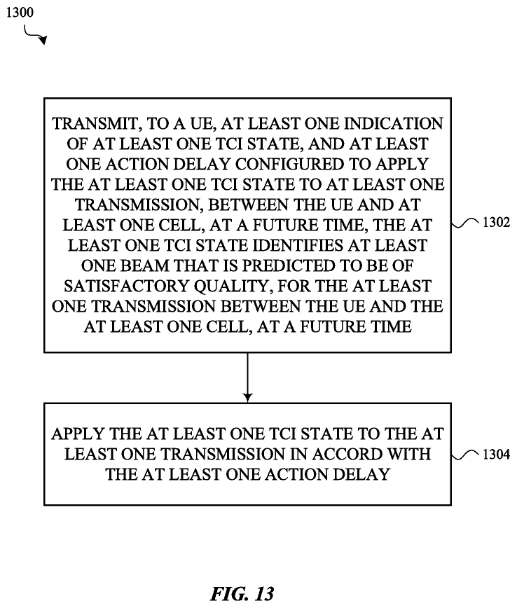

FIG. 13 shows an example method 1300 of wireless communication by a base station (e.g., a gNB or eNB), which method 1300 may be used to indicate one or more TCI states. The method 1300 may be performed by a processor of the base station, and transmissions and receptions initiated by the processor may be made using a transceiver of the base station.

At 1302, the method 1300 may include transmitting, to a UE, at least one indication of at least one TCI state, and at least one action delay configured to apply the at least one TCI state to at least one transmission (on a DL or an UL) between the UE and at least one cell at a future time. The at least one TCI state may identify at least one beam that is predicted to be of satisfactory quality, for the at least one transmission between the UE and the at least one cell, at a future time. Each action delay may apply to one TCI state, or to more than one TCI state, in the at least one TCI state. Thus, the number of TCI states and number of action delays may or may not have a one-to-one correspondence.

At 1304, the method 1300 may include applying the at least one TCI state to the at least one transmission in accord with the at least one action delay.

The method 1300 may be variously configured or modified as described with reference to FIG. 10.

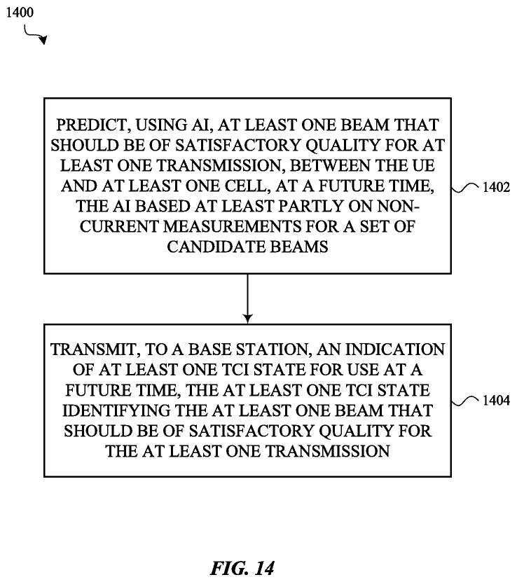

FIG. 14 shows an example method 1400 of wireless communication by a UE, which method 1400 may be used to predict and recommend one or more TCI states. The method 1400 may be performed by a processor of the UE, and transmissions and receptions initiated by the processor may be made using a transceiver of the UE.

At 1402, the method 1400 may include predicting, using AI, at least one beam that should be of satisfactory quality for at least one transmission, between the UE and at least one cell, at a future time. The AI may be based at least partly on non-current measurements for a set of candidate beams.

At 1404, the method 1400 may include transmitting, to a base station, an indication of at least one TCI state for use at a future time. The at least one TCI state may identify the at least one beam that should be of satisfactory quality for the at least one transmission. In some cases, at least one action delay may be transmitted for the at least one TCI state. Each action delay may be configured to activate or apply one TCI state, or more than one TCI state, in the at least one TCI state. Thus, the number of TCI states and number of action delays may or may not have a one-to-one correspondence.

In some embodiments, AI may be trained by the UE and used to predict the at least one beam that will be of satisfactory quality, for at least one transmission between the UE and at least one cell, at a future time. In some embodiments, AI may be trained at a base station and reported to the UE (e.g., in RRC signaling). In either case, the AI may be used by the UE to predict the at least one beam, and to identify at least one TCI state based on the prediction.

In some embodiments of the method 1400, the UE may transmit UE capability information indicating a most distant future time for which beam prediction is supported. In some cases, the most distant future time may be indicated in terms of a maximum action delay.

In some embodiments, a base station may configure the UE to transmit the indication of the at least one TCI state, at 1404. In these embodiments, the method 1400 may include receiving a configuration for transmitting the indication of the at least one TCI state, and transmitting the indication of the at least one TCI state in accord with the configuration. In some cases, the configuration may be received by higher layer signaling (e.g., in RRC signaling) and configure a list of TCI States and/or SSB/CSI-RS. The configuration may also or alternatively specify a number of TCI States for the UE to report. The configuration may also indicate a time for the report to be transmitted. The indication of the at least one TCI state, transmitted at 1404, may be transmitted as uplink control information (UCI) on a PUCCH or PUSCH, or in a MAC CE. In response to a base station receiving the indication of the at least one TCI state, the method 1400 may include receiving an acknowledgement from the base station. In some cases, the acknowledgement can be in the form of an indication to activate the at least one TCI state (or an indication to activate a TCI state, regardless of whether the TCI state is a TCI state recommended by the UE), as described with reference to FIGS. 6 and 9. The acknowledgement can also be in the form of an indication of at least one TCI state, as described with reference to FIGS. 10 and 11. The acknowledgement may also take the form of a physical downlink control channel (PDCCH). In one example, the PDCCH may be the one used to trigger a new transmission for the same HARQ process as the one used to make the transmission at 1404. In another example, the PDCCH may be transmitted in a configured dedicated search space or control resource set (CORESET).

In some embodiments, the method 1400 may include monitoring a set of conditions, and the UE may transmit the indication of the at least one TCI state, at 1404, after the set of conditions is met. In some cases, the set of conditions may include at least one of (or all of): whether beam prediction or TCI state recommendation is enabled by a base station; whether the at least one TCI state differs from a currently activated or indicated TCI state; or whether a predicted beam measurement (e.g., L1-RSRP and/or L1-SINR) for the at least one beam differs from an actual beam measurement for a currently activated or indicated TCI state. For the latter condition, a difference greater than a threshold difference may need to be met, with the predicted beam measurement having to be better than the actual beam measurement. The threshold difference (or offset) may be predefined or configured by higher layer signaling (e.g., in RRC signaling or a MAC CE). The indication of the at least one TCI state, transmitted at 1404, may be transmitted as UCI on a PUCCH or PUSCH, or in a MAC CE. A dedicated scheduling request (SR) may be configured for the UE to request an uplink resource(s) to report the at least one TCI state at 1404. If a dedicated SR is not configured, the method 1400 may include transmitting a normal SR or initiating a contention-based random access procedure. In response to a base station receiving the indication of the at least one TCI state, the method 1400 may include receiving an acknowledgement from the base station. In some cases, the acknowledgement can be in the form of an indication to activate the at least one TCI state (or an indication to activate a

TCI state, regardless of whether the TCI state is a TCI state recommended by the UE), as described with reference to FIGS. 6 and 9. The acknowledgement can also be in the form of an indication of at least one TCI state, as described with reference to FIGS. 10 and 11. The acknowledgement may also take the form of a PDCCH. In one example, the PDCCH may be the one used to trigger a new transmission for the same HARQ process as the one used to make the transmission at 1404. In another example, the PDCCH may be transmitted in a configured dedicated search space or control resource set (CORESET).

In some embodiments of the method 1400, the at least one TCI state may be indicated, at 1404, by a TCI index. In some embodiments, the TCI index can be replaced by an SSB resource indicator (SSBRI) and/or a CSI-RS resource indicator (CRI).

In some cases, one or more mobility criterion can be configured, and the mobility criterion may be used to determine how often the UE performs the method 1400 and/or how long an action delay may be. In some cases, the mobility criterion can be defined in terms of an RSRP change for a network beam within a time interval. For example, if the RSRP change is above a threshold, the UE may be assumed to be moving at a high speed and the frequency of performing the method 1400 may be high and/or the length of an action delay may be short. Similarly, if the RSRP change is below the threshold (or below a second threshold), the UE may be assumed to be moving at a low speed and the frequency of performing the method 1400 may be low and/or the length of an action delay may be long. Alternatively, the above parameters may be adjusted in different directions, or different adjustments may be made, based on a UE's predicted mobility status.

In some cases, the UE's mobility status may be determined by UE. In these cases, the UE may report UE assistance information (UAI), to a base station, to indicate the mobility status of the UE. In some cases, the UE may only report its mobility status after it detects a change in its mobility status. The threshold for reporting a change in mobility status may be predefined or configured by higher layer signaling (e.g., in RRC signaling or a MAC CE). In some cases, the UE's mobility status may be determined by a base station. In these cases, the base station may configure the UE to report an L1-RSRP measurement for one or more currently indicated TCI State(s). The base station may then configure how often the UE performs the method 1400 and/or how long an action delay may be by higher layer signaling or in DCI.

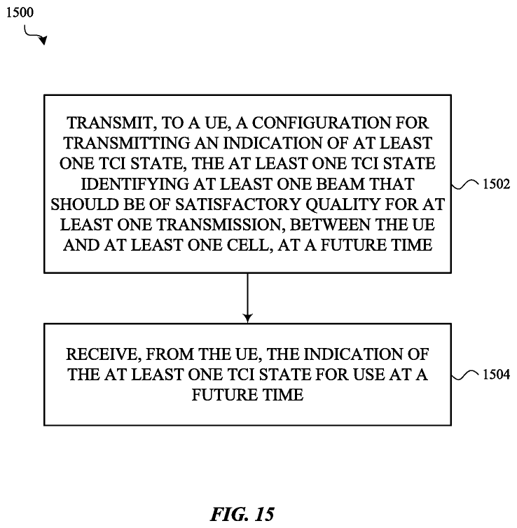

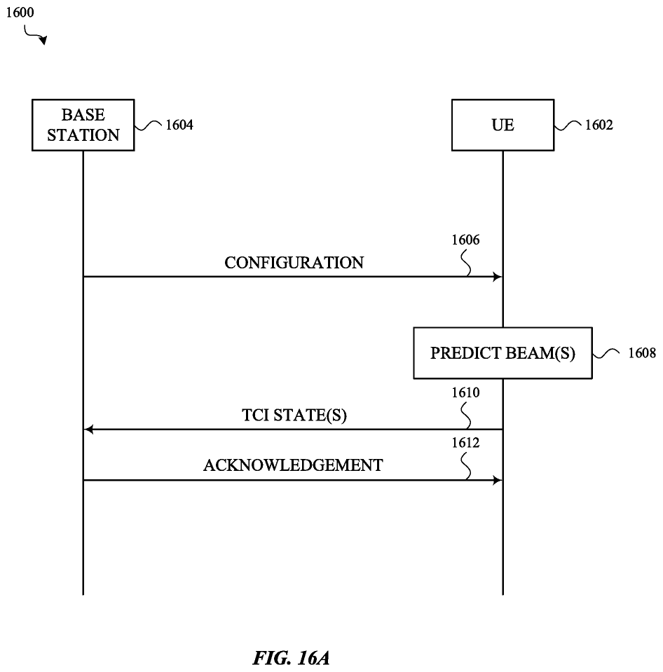

FIG. 15 shows an example method 1500 of wireless communication by a base station (e.g., a gNB or eNB), which method 1500 may be used to receive one or more TCI states recommended by a UE. The method 1500 may be performed by a processor of the base station, and transmissions and receptions initiated by the processor may be made using a transceiver of the base station.

At 1502, the method 1500 may optionally include transmitting, to a UE, a configuration for transmitting an indication of at least one TCI state. The at least one TCI state may identify at least one beam that should be of satisfactory quality for at least one transmission, between the UE and at least one cell, at a future time.

At 1504, the method 1500 may include receiving, from the UE, the indication of the at least one TCI state for use at a future time. In some cases, at least one action delay, configured to activate or apply the at least one TCI state, may also be received from the UE. Each action delay may apply to one TCI state, or to more than one TCI state, in the at least one TCI state. Thus, the number of TCI states and number of action delays may or may not have a one-to-one correspondence.

The method 1500 may be variously configured or modified as described with reference to FIG. 14.

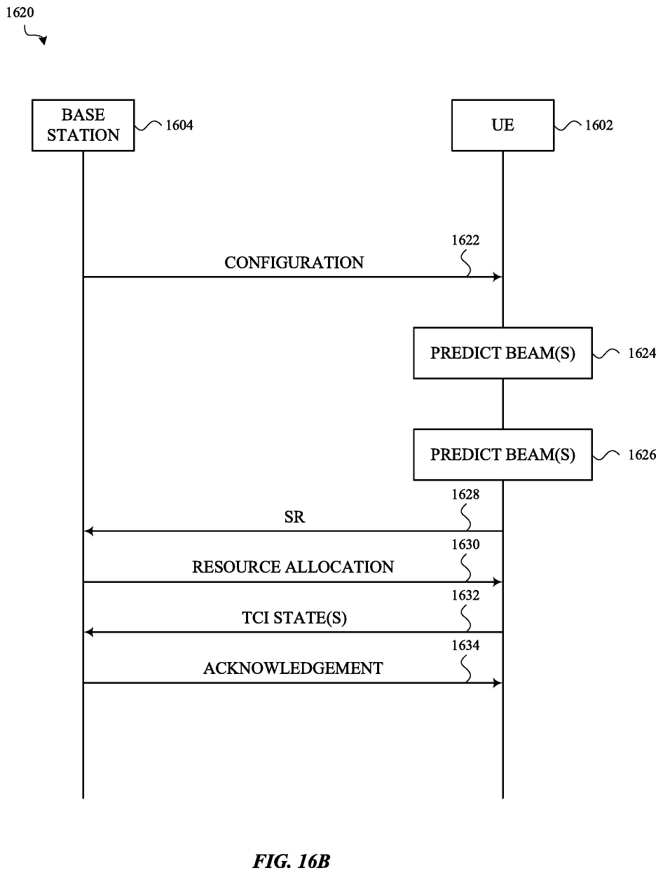

FIGS. 16A and 16B show example flow diagrams 1600, 1620 for transmission of one or more recommended TCI states from a UE to a base station. In the flow diagrams 1600, 1620, messages are transmitted between a UE 1602 and a base station 1604. The flow diagrams 1600, 1620 provide example illustrations of the methods described with reference to FIGS. 14 and 15.

As shown in FIG. 16A, and at 1606, the base station 1604 may transmit, to the UE 1602, a configuration for transmitting an indication of at least one TCI state. In some cases, the configuration may be received by higher layer signaling (e.g., in RRC signaling) and configure a list of TCI States and/or SSB/CSI-RS. The configuration may also indicate a time for the report to be transmitted. The configuration may include additional or alternative parameters, as described with reference to FIG. 14.

At 1608, the UE 1602 may predict, using AI, at least one beam that should be of satisfactory quality for the at least one transmission, between the UE and the at least one cell, at a future time. The AI may be based at least partly on non-current measurements for a set of candidate beams.

At 1610, the UE 1602 may transmit, to the base station 1604, the indication of the at least one TCI state for use at a future time. The at least one TCI state may identify the at least one beam that should be of satisfactory quality for the at least one transmission. In some cases, at least one action delay may be transmitted for the at least one TCI state. Each action delay may apply to one TCI state, or to more than one TCI state, in the at least one TCI state. Thus, the number of TCI states and number of action delays may or may not have a one-to-one correspondence.

At 1612, the base station 1604 may transmit an acknowledgement to the UE 1602. The acknowledgement may be transmitted, for example, in any of the ways described with reference to FIG. 14.

As shown in FIG. 16B, and at 1622, the base station 1604 may optionally transmit, to the UE 1602, a configuration for transmitting an indication of at least one TCI state. In some cases, the configuration may be received by higher layer signaling (e.g., in RRC signaling) and configure a list of TCI States and/or SSB/CSI-RS. The configuration may include additional or alternative parameters, as described with reference to FIG. 14.

At 1624, the UE 1602 may predict, using AI, at least one beam that should be of satisfactory quality for the at least one transmission, between the UE and the at least one cell, at a future time. The AI may be based at least partly on non-current measurements for a set of candidate beams.

At 1626, the UE 1602 may monitor a set of conditions, as described with reference to FIG. 14. The conditions may be monitored before, during, and/or after the operation(s) at 1624.

At 1628, and upon determining the set of conditions is met, the UE 1602 may transmit an SR to the base station 1604.

At 1630, the base station 1604 may indicate a resource allocation for the UE 1602 to transmit at least one recommended TCI state (though the base station need not indicate a resource allocation at all, in which case the UE may not transmit the at least one recommended TCI state).

At 1632, the UE 1602 may transmit, to the base station 1604, the indication of the at least one TCI state for use at a future time. The at least one TCI state may identify the at least one beam that should be of satisfactory quality for the at least one transmission. In some cases, at least one action delay may be transmitted for the at least one TCI state. Each action delay may apply to one TCI state, or to more than one TCI state, in the at least one TCI state. Thus, the number of TCI states and number of action delays may or may not have a one-to-one correspondence.

At 1634, the base station 1604 may transmit an acknowledgement to the UE 1602. The acknowledgement may be transmitted, for example, in any of the ways described with reference to FIG. 14.

Embodiments contemplated herein include an apparatus having means to perform one or more elements of the method 600, 900, 1000, 1300, 1400, or 1500. In the context of method 600, 1000, or 1400, this apparatus may be, for example, an apparatus of a UE (such as a wireless device 1802 that is a UE, as described herein). In the context of method 900, 1300, or 1500, this apparatus may be, for example, an apparatus of a base station (such as a network device 1820 that is a base station, as described herein).

Embodiments contemplated herein include one or more non-transitory computer-readable media storing instructions to cause an electronic device, upon execution of the instructions by one or more processors of the electronic device, to perform one or more elements of the method 600, 900, 1000, 1300, 1400, or 1500. In the context of method 600, 1000, or 1400, this non-transitory computer-readable media may be, for example, a memory of a UE (such as a memory 1806 of a wireless device 1802 that is a UE, as described herein). In the context of method 900, 1300, or 1500, this non-transitory computer-readable media may be, for example, a memory of a base station (such as a memory 1824 of a network device 1820 that is a base station, as described herein).

Embodiments contemplated herein include an apparatus having logic, modules, or circuitry to perform one or more elements of the method 600, 900, 1000, 1300, 1400, or 1500. In the context of method 600, 1000, or 1400, this apparatus may be, for example, an apparatus of a UE (such as a wireless device 1802 that is a UE, as described herein). In the context of method 900, 1300, or 1500, this apparatus may be, for example, an apparatus of a base station (such as a network device 1820 that is a base station, as described herein).

Embodiments contemplated herein include an apparatus having one or more processors and one or more computer-readable media, using or storing instructions that, when executed by the one or more processors, cause the one or more processors to perform one or more elements of the method 600, 900, 1000, 1300, 1400, or 1500. In the context of method 600, 1000, or 1400, this apparatus may be, for example, an apparatus of a UE (such as a wireless device 1802 that is a UE, as described herein). In the context of the method 900, 1300, or 1500, this apparatus may be, for example, an apparatus of a base station (such as a network device 1820 that is a base station, as described herein).

Embodiments contemplated herein include a signal as described in or related to one or more elements of the method 600, 900, 1000, 1300, 1400, or 1500.

Embodiments contemplated herein include a computer program or computer program product having instructions, wherein execution of the program by a processor causes the processor to carry out one or more elements of the method 600, 900, 1000, 1300, 1400, or 1500. In the context of method 600, 1000, or 1400, the processor may be a processor of a UE (such as a processor(s) 1804 of a wireless device 1802 that is a UE, as described herein), and the instructions may be, for example, located in the processor and/or on a memory of the UE (such as a memory 1806 of a wireless device 1802 that is a UE, as described herein). In the context of method 900, 1300, or 1500, the processor may be a processor of a base station (such as a processor(s) 1822 of a network device 1820 that is a base station, as described herein), and the instructions may be, for example, located in the processor and/or on a memory of the base station (such as a memory 1824 of a network device 1820 that is a base station, as described herein).

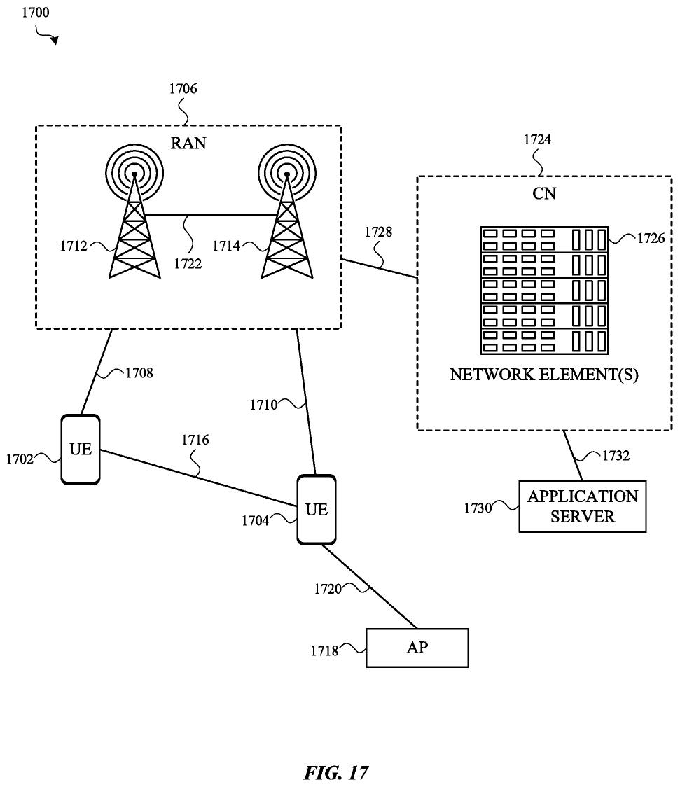

FIG. 17 illustrates an example architecture of a wireless communication system 1700, according to embodiments disclosed herein. The following description is provided for an example wireless communication system 1700 that operates in conjunction with the LTE system standards and/or 5G or NR system standards as provided by 3GPP technical specifications.

As shown by FIG. 17, the wireless communication system 1700 includes UE 1702 and UE 1704 (although any number of UEs may be used). In this example, the UE 1702 and the UE 1704 are illustrated as smartphones (e.g., handheld touchscreen mobile computing devices connectable to one or more cellular networks), but may also comprise any mobile or non-mobile computing device configured for wireless communication.

The UE 1702 and UE 1704 may be configured to communicatively couple with a RAN 1706. In embodiments, the RAN 1706 may be NG-RAN, E-UTRAN, etc. The UE 1702 and UE 1704 utilize connections (or channels) (shown as connection 1708 and connection 1710, respectively) with the RAN 1706, each of which comprises a physical communications interface. The RAN 1706 can include one or more base stations, such as base station 1712 and base station 1714, that enable the connection 1708 and connection 1710.

In this example, the connection 1708 and connection 1710 are air interfaces to enable such communicative coupling, and may be consistent with RAT(s) used by the RAN 1706, such as, for example, an LTE and/or NR.

In some embodiments, the UE 1702 and UE 1704 may also directly exchange communication data via a sidelink interface 1716. The UE 1704 is shown to be configured to access an access point (shown as AP 1718) via connection 1720. By way of example, the connection 1720 can comprise a local wireless connection, such as a connection consistent with any IEEE 802.11 protocol, wherein the AP 1718 may comprise a Wi-Fi® router. In this example, the AP 1718 may be connected to another network (for example, the Internet) without going through a CN 1724.

In embodiments, the UE 1702 and UE 1704 can be configured to communicate using orthogonal frequency division multiplexing (OFDM) communication signals with each other or with the base station 1712 and/or the base station 1714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1712 or base station 1714 may be implemented as one or more software entities running on server computers as part of a virtual network. In addition, or in other embodiments, the base station 1712 or base station 1714 may be configured to communicate with one another via interface 1722. In embodiments where the wireless communication system 1700 is an LTE system (e.g., when the CN 1724 is an EPC), the interface 1722 may be an X2 interface. The X2 interface may be defined between two or more base stations (e.g., two or more eNBs and the like) that connect to an EPC, and/or between two eNBs connecting to the EPC. In embodiments where the wireless communication system 1700 is an NR system (e.g., when CN 1724 is a 5GC), the interface 1722 may be an Xn interface. The Xn interface is defined between two or more base stations (e.g., two or more gNBs and the like) that connect to 5GC, between a base station 1712 (e.g., a gNB) connecting to 5GC and an eNB, and/or between two eNBs connecting to 5GC (e.g., CN 1724).

The RAN 1706 is shown to be communicatively coupled to the CN 1724. The CN 1724 may comprise one or more network elements 1726, which are configured to offer various data and telecommunications services to customers/subscribers (e.g., users of UE 1702 and UE 1704) who are connected to the CN 1724 via the RAN 1706. The components of the CN 1724 may be implemented in one physical device or separate physical devices including components to read and execute instructions from a machine-readable or computer-readable medium (e.g., a non-transitory machine-readable storage medium).

In embodiments, the CN 1724 may be an EPC, and the RAN 1706 may be connected with the CN 1724 via an S1 interface 1728. In embodiments, the SI interface 1728 may be split into two parts, an S1 user plane (S1-U) interface, which carries traffic data between the base station 1712 or base station 1714 and a serving gateway (S-GW), and the S1-MME interface, which is a signaling interface between the base station 1712 or base station 1714 and mobility management entities (MMEs).

In embodiments, the CN 1724 may be a 5GC, and the RAN 1706 may be connected with the CN 1724 via an NG interface 1728. In embodiments, the NG interface 1728 may be split into two parts, an NG user plane (NG-U) interface, which carries traffic data between the base station 1712 or base station 1714 and a user plane function (UPF), and the S1 control plane (NG-C) interface, which is a signaling interface between the base station 1712 or base station 1714 and access and mobility management functions (AMFs).

Generally, an application server 1730 may be an element offering applications that use internet protocol (IP) bearer resources with the CN 1724 (e.g., packet switched data services).

The application server 1730 can also be configured to support one or more communication services (e.g., VoIP sessions, group communication sessions, etc.) for the UE 1702 and UE 1704 via the CN 1724. The application server 1730 may communicate with the CN 1724 through an IP communications interface 1732.

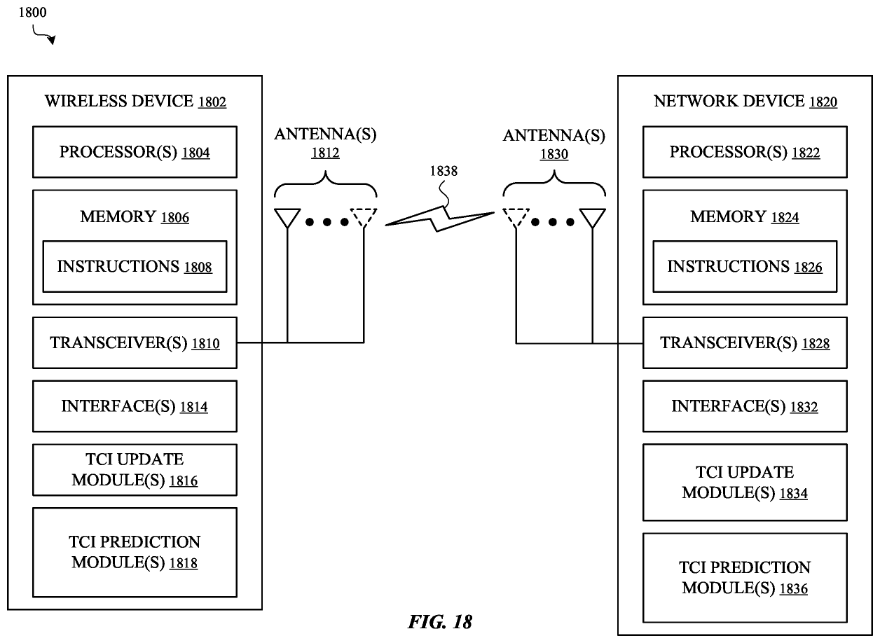

FIG. 18 illustrates a system 1800 for performing signaling 1838 between a wireless device 1802 and a network device 1820, according to embodiments disclosed herein. The system 1800 may be a portion of a wireless communications system as herein described. The wireless device 1802 may be, for example, a UE of a wireless communication system. The network device 1820 may be, for example, a base station (e.g., an eNB or a gNB) of a wireless communication system.

The wireless device 1802 may include one or more processor(s) 1804. The processor(s) 1804 may execute instructions such that various operations of the wireless device 1802 are performed, as described herein. The processor(s) 1804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1802 may include a memory 1806. The memory 1806 may be a non-transitory computer-readable storage medium that stores instructions 1808 (which may include, for example, the instructions being executed by the processor(s) 1804). The instructions 1808 may also be referred to as program code or a computer program. The memory 1806 may also store data used by, and results computed by, the processor(s) 1804.

The wireless device 1802 may include one or more transceiver(s) 1810 that may include radio frequency (RF) transmitter and/or receiver circuitry that use the antenna(s) 1812 of the wireless device 1802 to facilitate signaling (e.g., the signaling 1838) to and/or from the wireless device 1802 with other devices (e.g., the network device 1820) according to corresponding RATs.

The wireless device 1802 may include one or more antenna(s) 1812 (e.g., one, two, four, or more). For embodiments with multiple antenna(s) 1812, the wireless device 1802 may leverage the spatial diversity of such multiple antenna(s) 1812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1802 may be accomplished according to precoding (or digital beamforming) that is applied at the wireless device 1802 that multiplexes the data streams across the antenna(s) 1812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1802 may implement analog beamforming techniques, whereby phases of the signals sent by the antenna(s) 1812 are relatively adjusted such that the (joint) transmission of the antenna(s) 1812 can be directed (this is sometimes referred to as beam steering).

The wireless device 1802 may include one or more interface(s) 1814. The interface(s) 1814 may be used to provide input to or output from the wireless device 1802. For example, a wireless device 1802 that is a UE may include interface(s) 1814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1810/antenna(s) 1812 already described) that allow for communication between the UE and other devices and may operate according to known protocols (e.g., Wi-Fi®, Bluetooth®, and the like).

The wireless device 1802 may include a TCI update module 1816 and/or a TCI prediction module 1818. The TCI update module 1816 and TCI prediction module 1818 may be implemented via hardware, software, or combinations thereof. For example, the TCI update module 1816 and TCI prediction module 1818 may be implemented as a processor, circuit, and/or instructions 1808 stored in the memory 1806 and executed by the processor(s) 1804. In some examples, the TCI update module 1816 and TCI prediction module 1818 may be integrated within the processor(s) 1804 and/or the transceiver(s) 1810. For example, the TCI update module 1816 and TCI prediction module 1818 may be implemented by a combination of software components (e.g., executed by a DSP or a general processor) and hardware components (e.g., logic gates and circuitry) within the processor(s) 1804 or the transceiver(s) 1810.

The TCI update module 1816 may be used for various aspects of the present disclosure, for example, aspects of FIGS. 1-16. The TCI update module 1816 may be configured to, for example, activate or apply one or more TCI states indicated by another device (e.g., the network device 1820).

The TCI prediction module 1818 may be used for various aspects of the present disclosure, for example, aspects of FIGS. 1-16. The TCI prediction module 1818 may be configured to, for example, predict at least one beam that should be of satisfactory quality for at least one transmission (on a DL or an UL) at a future time.

The network device 1820 may include one or more processor(s) 1822. The processor(s) 1822 may execute instructions such that various operations of the network device 1820 are performed, as described herein. The processor(s) 1822 may include one or more baseband processors implemented using, for example, a CPU, a DSP, an ASIC, a controller, an FPGA device, another hardware device, a firmware device, or any combination thereof configured to perform the operations described herein.

The network device 1820 may include a memory 1824. The memory 1824 may be a non-transitory computer-readable storage medium that stores instructions 1826 (which may include, for example, the instructions being executed by the processor(s) 1822). The instructions 1826 may also be referred to as program code or a computer program. The memory 1824 may also store data used by, and results computed by, the processor(s) 1822.

The network device 1820 may include one or more transceiver(s) 1828 that may include RF transmitter and/or receiver circuitry that use the antenna(s) 1830 of the network device 1820 to facilitate signaling (e.g., the signaling 1838) to and/or from the network device 1820 with other devices (e.g., the wireless device 1802) according to corresponding RATs.

The network device 1820 may include one or more antenna(s) 1830 (e.g., one, two, four, or more). In embodiments having multiple antenna(s) 1830, the network device 1820 may perform MIMO, digital beamforming, analog beamforming, beam steering, etc., as has been described.

The network device 1820 may include one or more interface(s) 1832. The interface(s) 1832 may be used to provide input to or output from the network device 1820. For example, a network device 1820 that is a base station may include interface(s) 1832 made up of transmitters, receivers, and other circuitry (e.g., other than the transceiver(s) 1828/antenna(s) 1830 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1820 may include a TCI update module 1834 and/or a TCI prediction module 1836. The TCI update module 1834 and TCI prediction module 1836 may be implemented via hardware, software, or combinations thereof. For example, the TCI update module 1834 and TCI prediction module 1836 may be implemented as a processor, circuit, and/or instructions 1826 stored in the memory 1824 and executed by the processor(s) 1822. In some examples, the TCI update module 1834 and TCI prediction module 1836 may be integrated within the processor(s) 1822 and/or the transceiver(s) 1828. For example, the TCI update module 1834 and TCI prediction module 1836 may be implemented by a combination of software components (e.g., executed by a DSP or a general processor) and hardware components (e.g., logic gates and circuitry) within the processor(s) 1822 or the transceiver(s) 1828.

The TCI update module 1834 may be used for various aspects of the present disclosure, for example, aspects of FIGS. 1-16. The TCI update module 1834 may be configured to, for example, activate or indicate one or more TCI states to be used by another device (e.g., the wireless device 1802).

The TCI prediction module 1836 may be used for various aspects of the present disclosure, for example, aspects of FIGS. 1-16. The TCI prediction module 1836 may be configured to, for example, predict at least one beam that should be of satisfactory quality for at least one transmission between a UE (e.g., the wireless device 1802) and at least one cell (on a DL or an UL) at a future time.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, via the transceiver,
at least one indication to activate at least one transmission configuration indicator (TCI) state, the at least one TCI state identifies at least one beam that is predicted to be of satisfactory quality for at least one transmission between the UE and at least one cell at a future time; and
at least one action delay configured to activate the at least one TCI state;
identify the at least one beam in accord with the TCI state; and
activate the at least one TCI state in accord with the at least one action delay.

2. The UE of claim 1, wherein the at least one indication to activate the at least one TCI state is received in at least one medium access control (MAC) control element (CE) (MAC CE).

3. The UE of claim 2, wherein:
a MAC CE of the at least one MAC CE identifies a number of TCI states or TCI codepoints corresponding to the at least one TCI state; and
the MAC CE identifies an action delay that applies to each TCI state or TCI codepoint of the number of TCI states or TCI codepoints identified in the MAC CE.

4. The UE of claim 2, wherein:
a MAC CE of the at least one MAC CE identifies multiple TCI states or TCI codepoints corresponding to the at least one TCI state; and
the MAC CE identifies an action delay per TCI state or TCI codepoint in the multiple TCI states or TCI codepoints.

5. The UE of claim 2, wherein:
a MAC CE of the at least one MAC CE identifies a number of TCI states or TCI codepoints corresponding to the at least one TCI state; and
the processor is configured to receive, via the transceiver, downlink control information (DCI) to schedule a physical downlink shared channel (PDSCH) containing the MAC CE, the DCI identifies an action delay that applies to each TCI state or TCI codepoint of the number of TCI states or TCI codepoints identified in the MAC CE.

6. The UE of claim 2, wherein:
the at least one MAC CE is one MAC CE;
the MAC CE identifies at least one TCI codepoint corresponding to the at least one TCI state;
each TCI codepoint of the at least one TCI codepoint is associated with multiple TCI states; and
different action delays are indicated for different TCI states of the multiple TCI states.

7. The UE of claim 2, wherein:
the at least one action delay is,
selected from a predefined first set of at least one candidate action delay; or
selected from a set of a second set of at least one candidate action delay configured by radio resource control (RRC) signaling.

8. The UE of claim 1, wherein the processor is configured to receive, via the transceiver, a second indication, the second indication indicates whether the at least one indication to activate the at least one TCI state overwrites previous indications to activate the at least one TCI state.

9. The UE of claim 1, wherein the processor is configured to automatically overwrite previous indications to activate the at least one TCI state upon receiving the indication to activate the at least one TCI state.

10. A user equipment (UE), comprising:
a transceiver; and
a processor configured to,
receive, via the transceiver,
at least one indication of at least one transmission configuration indicator (TCI) state, the at least one TCI state identifes at least one beam that is predicted to be of satisfactory quality for at least one transmission between the UE and at least one cell at a future time; and
at least one action delay configured to apply the at least one TCI state;
identify the at least one beam in accord with the TCI state; and
apply the at least one TCI state to the at least one transmission in accord with the at least one action delay.

11. The UE of claim 10, wherein the at least one indication of the at least one TCI state is received in at least one medium access control (MAC) control element (CE) (MAC CE).

12. The UE of claim 10, wherein the at least one indication of the at least one TCI state is received in downlink control information (DCI).

13. The UE of claim 12, wherein the DCI includes at least one dedicated field that identifies the at least one action delay.

14. The UE of claim 10, wherein:
the processor is configured to, before the at least one TCI state is applied to the at least one transmission,
measure a set of channel state information reference signal (CSI-RS) resources transmitted from at least one antenna port associated with the at least one TCI state; and
refine at least one UE beam associated with the at least one TCI state.

15. The UE of claim 10, wherein:
the processor is configured to,
before the at least one TCI state is applied to the at least one transmission, determine a reference signal received power (RSRP) for at least one channel state information reference signal (CSI-RS) resource transmitted from at least one antenna port associated with the at least one TCI state; and
transmit, via the transceiver, after a TCI state in the at least one TCI state is applied to the at least one transmission, at least one report based on the RSRP.

16. A user equipment (UE), comprising:
a transceiver; and
a processor configured to,
predict, using artificial intelligence, at least one beam that should be of satisfactory quality for at least one transmission, between the UE and at least one cell, at a future time, the artificial intelligence based at least partly on non-current measurements for a set of candidate beams; and
transmit, via the transceiver and to a base station, an indication of at least one transmission configuration indicator (TCI) state for use at a future time, the at least one TCI state identifies the at least one beam that should be of satisfactory quality for the at least one transmission.

17. The UE of claim 16, wherein the processor is configured to transmit, via the transceiver, UE capability information indicating a most distant future time for which beam prediction is supported.

18. The UE of claim 16, wherein:
the processor is configured to,
receive, via the transceiver, a configuration for transmitting the indication of the at least one TCI state; and
transmit the indication of the at least one TCI state in accord with the configuration.

19. The UE of claim 16, wherein:
the processor is configured to,
monitor a set of conditions including at least one of,
whether beam prediction or TCI state recommendation is enabled by a base station;
whether the at least one TCI state differs from a currently activated or indicated TCI state; or
whether a predicted beam measurement for the at least one beam differs from an actual beam measurement for a currently activated or indicated TCI state; and
transmit the indication of the at least one TCI state after the set of conditions is met.

20. The UE of claim 16, wherein the processor is configured to predict the at least one beam based on a mobility criterion of the UE.
